(19) United States
(12) Patent Application Publication
(10) Pub. No.: US 2006/0049660 A1
(43) Pub. Date: Mar. 9, 2006

(54) Removable hard top system

(76) Inventors: Bernard W. Schaller, Brownstown, MI (US); Paul Hunkele, Brooklyn, MI (US); James C. Powell, Sterling Heights, MI (US); Jeffrey Yachnin, Rochester Hills, MI (US); Christopher C. Dowdey, Grosse Ile, MI (US)

Correspondence Address: HARNESS, DICKEY & PIERCE, P.L.C., P.O. BOX 828, BLOOMFIELD HILLS, MI, 48303, US

(21) Appl. No.: 11/204,370

(22) Filed: Aug. 15, 2005

Related U.S. Application Data
(60) Provisional application No. 60/607,981, filed on Sep. 8, 2004.

(51) Int. Cl. B60J 7/20

(52) U.S. Cl. 296/103

(57) ABSTRACT

In accordance with the present invention, a removable hard top roof system that can be used to replace a convertible roof for a vehicle is disclosed. The hard top roof system is offered as a module and includes a substantially rigid roof panel and a lift gate that is coupled to the roof panel. The panel and lift gate are attachable to the vehicle in place of the convertible roof. In another aspect of the present invention, the removable roof panel includes a structural support that is coupled to the roof panel. In yet another aspect of the present invention, the automotive vehicle includes a water trough that is hidden from view regardless of the positions of movable members of the automotive vehicle. In still another aspect of the present invention, a removable roof panel is attached to an automotive vehicle by the use of a bracket that is attached to a front header of the vehicle.

### CROSS-REFERENCE TO RELATED APPLICATIONS

This application claims the benefit of U.S. Provisional Application No. 60/607,981, filed on Sep. 8, 2004. The disclosure of the above application is incorporated herein by reference.

### BACKGROUND AND SUMMARY OF THE INVENTION

The present invention relates to automotive vehicles and more particularly to automotive vehicles having a removable hard top roof. Automotive vehicles having a convertible roof are increasing in popularity and manufacturers are continually looking for ways to offer a vehicle with a convertible roof at a reduced cost. In addition to offering a convertible roof, some consumers still prefer the styling and practicality of a vehicle having a hard top roof that is non-removable or substantially fixed in place. The manufacturing costs of providing a vehicle with both a convertible roof option and a hard top fixed or substantially fixed roof can be prohibitive, especially in low volume or specialty vehicles. That is, the engineering and design costs associated with preparing a vehicle to receive both a convertible roof and to be made with a fixed roof or a substantially fixed roof and the tooling associated therewith can prevent a manufacturer from offering both configurations for a given vehicle.

As a result, some manufacturers may offer a vehicle in only a single configuration that utilizes a convertible roof. Due to this limited selection, some consumers who are otherwise interested in purchasing the vehicle may be deterred by the fact that the vehicle is only offered in a convertible roof configuration. Furthermore, when the vehicle utilizes a convertible roof configuration, the management of water that runs off of the top requires the use of troughs. The troughs utilized for the vehicle when having a convertible roof configuration may or may not be useful for catching water when replacing the convertible roof with a hard top roof. Additionally, when trying to utilize the existing water troughs, a non-pleasing appearance may result.

Thus, it would be advantageous if a vehicle designed to employ a convertible roof could be easily and economically configured to also provide a hard top roof option. Moreover, it would also be advantageous if the hard top roof configuration would utilize many of the existing hardware or structural pieces that currently exist in the convertible roof configuration.

In accordance with the present invention, a removable hard top roof system that can be used to replace a convertible roof for a vehicle is disclosed. The hard top roof system is offered as a module and includes a substantially rigid roof panel and a lift gate that is coupled to the roof panel. The panel and lift gate are attachable to the vehicle in place of the convertible roof. In another aspect of the present invention, the removable roof panel includes a structural support that is coupled to the roof panel. In yet another aspect of the present invention, the automotive vehicle includes a water trough that is hidden from view regardless of the positions of movable members of the automotive vehicle. In still another aspect of the present invention, a removable roof panel is attached to an automotive vehicle by the use of a bracket that is attached to a front header of the vehicle.

The present invention is advantageous in that it can utilize existing mounting locations and/or hardware that are used for retaining a convertible roof on the vehicle. This facilitates the manufacturing of a vehicle with either a convertible roof or a removable hard top system. Additionally, the ease of manufacturing reduces the assembly costs and labor associated with the production of both configurations. The hiding of a water trough from view is advantageous in that it provides an aesthetically pleasing appearance and custom fit and finish for the vehicle. The use of a structural support in conjunction with the removable roof panel is advantageous in that it provides a simple cost efficient way of structurally reinforcing the roof panel. Additional advantages and features of the present invention will become apparent from the following description and appended claims taken in conjunction with the accompanying drawings. It should be understood that the detailed description and specific examples, while indicating the preferred embodiment of the invention, are intended for purposes of illustration only and not intended to limit the scope of the invention.

### BRIEF DESCRIPTION OF THE DRAWINGS

The present invention will become more fully understood from the detailed description and the accompanying drawings, wherein:

FIGS. 1A and 1B are perspective views of a vehicle having a removable hard top roof system according to the principle of the present invention with the tailgate in a closed and open position, respectively;

FIG. 2A is an exploded view of the roof panel of the roof system of FIG. 1A;

FIG. 2B is an exploded view of the lift gate of the roof system of FIG. 1;

FIG. 2C is an exploded view of the roll bar assembly of the roof system of FIG. 1;

FIG. 3 is a cross-sectional view of the roof system of FIG. 1 along line 3-3;

FIG. 4 is a cross-sectional view of the roof system of FIG. 1 along line 4-4;

FIG. 5 is a cross-sectional view of the roof system of FIG. 1 along line 5-5;

FIG. 6 is a cross-sectional view of the roof system of FIG. 1 along line 6-6;

FIGS. 7A-7C are cross-sectional views of the roof system of FIG. 1 along lines 7A-7A, 7B-7B and 7C-7C of FIG. 1;

FIGS. 8A-8I are perspective views of the assembly process of the present invention;

FIG. 9 is a cross-sectional view of the roof system along line 9-9 of FIG. 1 showing a first alternate embodiment of the roof system; and

FIG. 10 is a cross-sectional view of the roof system along line 10-10 of FIG. 1 showing the alternate embodiment of the roof system.

### DETAILED DESCRIPTION OF THE PREFERRED EMBODIMENTS

The following description of the preferred embodiments is merely exemplary in nature and is in no way intended to limit the invention, its application, or uses.

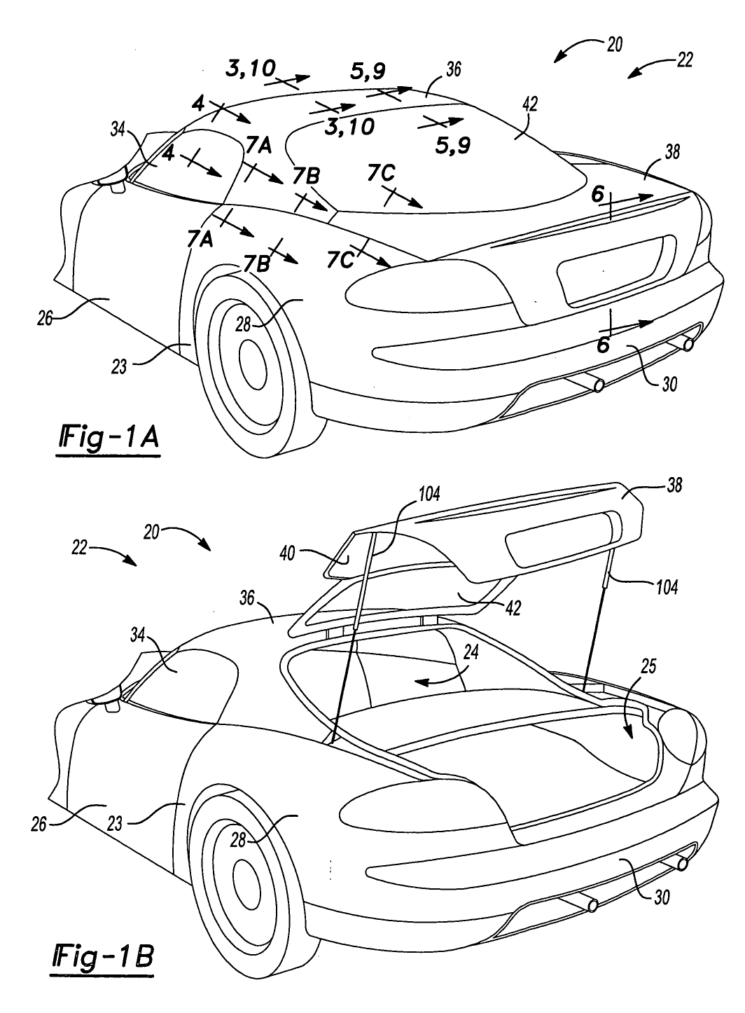

An automotive vehicle 20 having a hard top roof system 22 according to the principles of the present invention is shown in FIGS. 1A and 1B. Vehicle 20 has a body 23 that includes a passenger seating area 24 and a storage area 25 rearward of passenger area 24. Body 23 also includes side doors 26, rear quarter panels 28, a rear bumper fascia 30 and a front windshield 32. Each side door 26 includes a frameless side window 34.

Roof system 22 is intended to be fixedly mounted to vehicle 20 in place of a convertible roof system (not shown). That is, vehicle 20 is designed to be fitted with a convertible roof system and hard top roof system 22 is designed to be attached to vehicle 20 in place of the convertible roof system. Once installed, roof system 22 is not intended to be taken on and off vehicle 20. If desired, however, roof system 22 may be removed from vehicle 20. Roof system 22 may use the same or different mounting locations as the convertible roof depending upon the design of body 23 and the needs of roof system 22. It should be appreciated, however, that roof system 22 can be mounted to a vehicle that is not configured to accommodate a convertible roof system.

Roof system 22 includes a substantially rigid hard top roof panel 36 and a lift gate 38. Roof system 22 covers passenger seating area 24 and storage area 25. Lift gate 38 includes a frame 40 and a rear window or backlite 42. Lift gate 38 is operable between an open position, as shown in FIG. 1B, and a closed position, as shown in FIG. 1A, to selectively allow access to and enclose storage area 25, respectively.

Roof system 22 and the various components of that system are shown symmetrical about a longitudinal, fore-and-aft center line (not shown) of vehicle 20. For brevity, at times only one side of roof system 22 may be shown and/or discussed, however, it should be understood that components for the other side are also provided as part of roof system 22 and are mirrored images of the side shown and/or discussed.

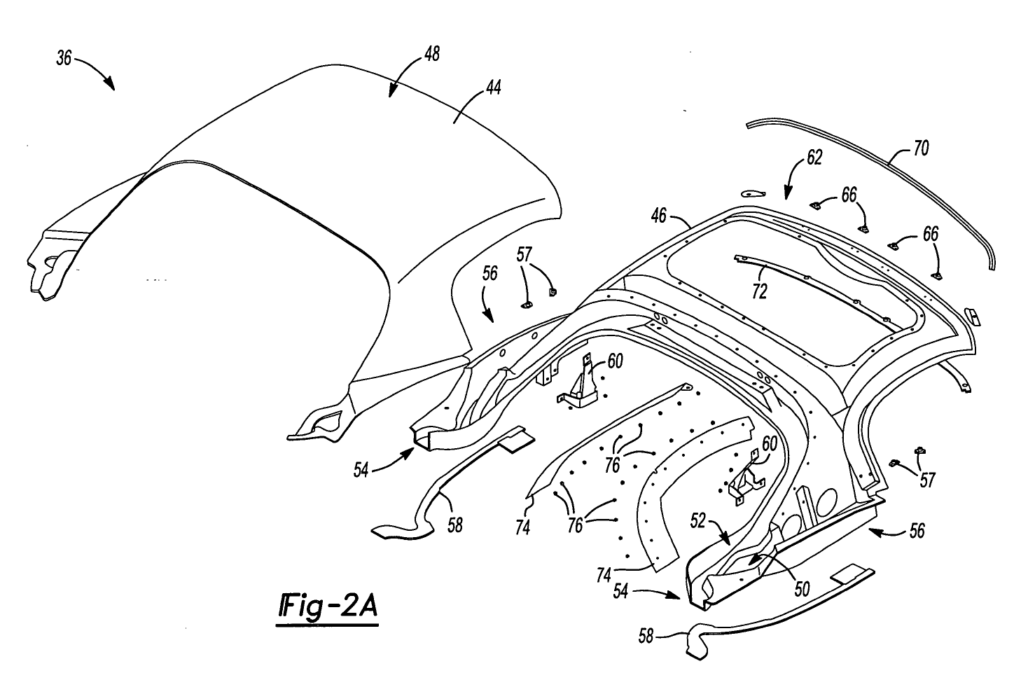

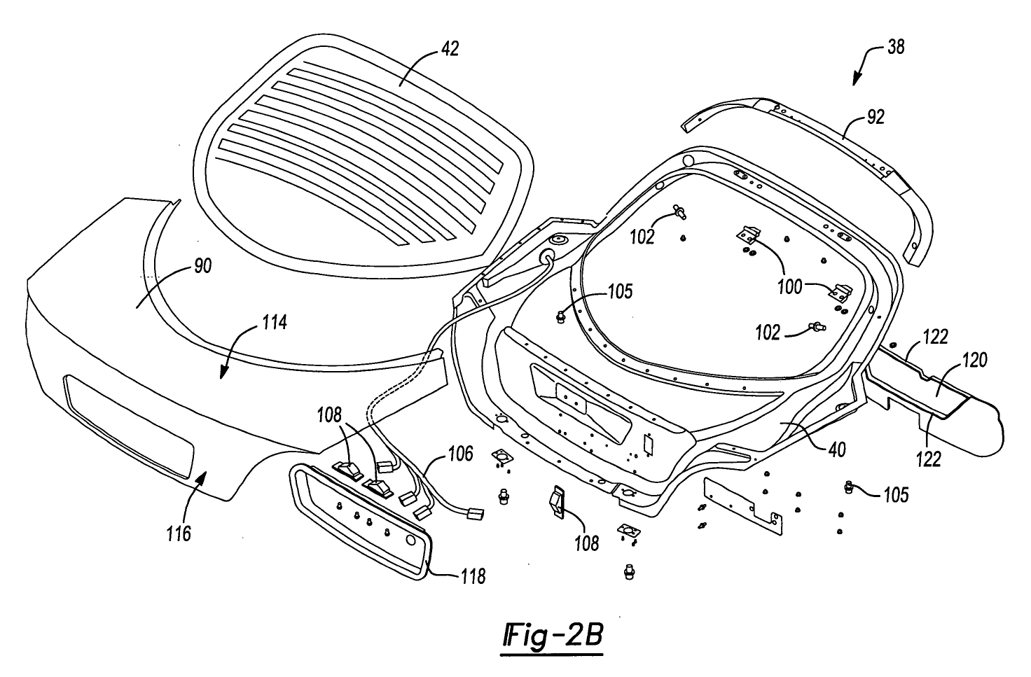

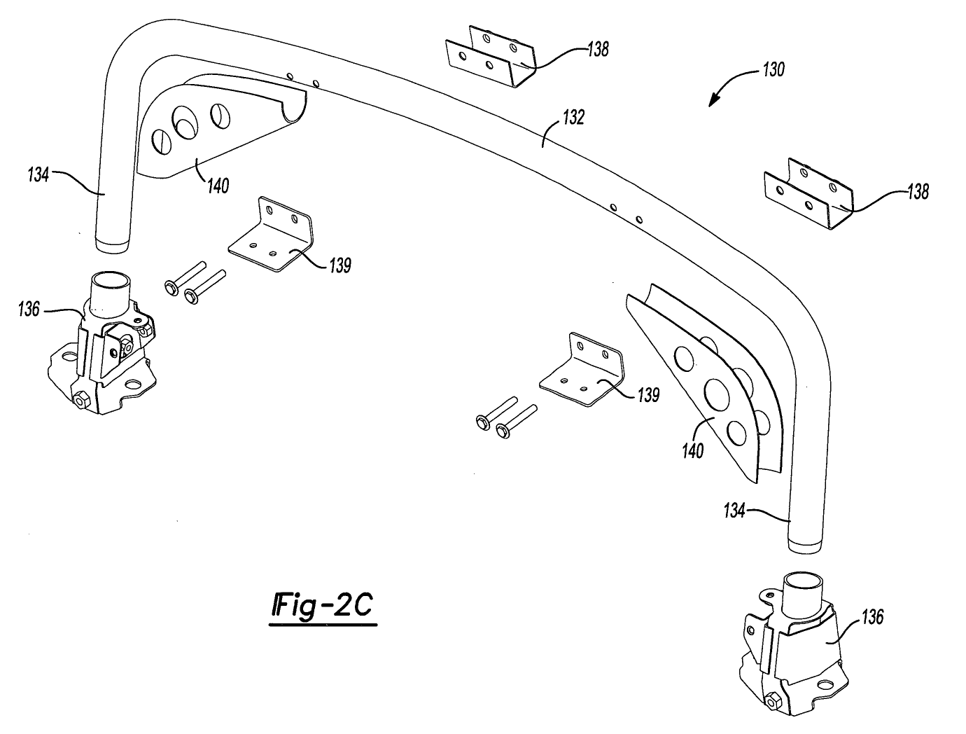

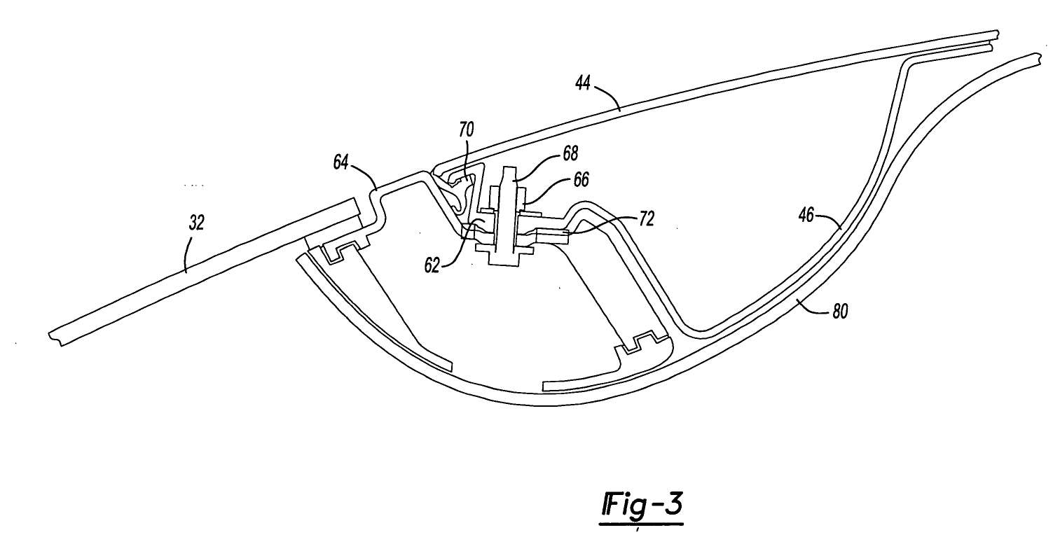

Referring now to FIG. 2A, details of roof panel 36 are shown. Roof panel 36 includes an outer panel 44 and an inner panel 46 each preferably made from a sheet molded compound. Outer and inner panels 44, 46 are adhesively bonded to one another at various locations to act as a single unitary roof panel 36. Roof panel 36 is mounted to body 23 of vehicle 20 with bolts at various locations to essentially fixedly secure roof panel 36 to vehicle 20, as described in more detail below. An exterior surface 48 of outer panel 44 forms the exterior surface of roof panel 36 and is preferably painted to match body 23.

Inner panel 46 includes two water troughs 50, 52 on each of the driver's and passenger's side of vehicle 20. First troughs 50 catch water that flows along outer panel 44 adjacent quarter panels 28. First troughs 50 are essentially hidden from view, as described in more detail below. Second troughs 52 catch water that flows along lift gate 38 adjacent outer panel 44 and quarter panels 28. First troughs 50 direct water flowing therein into second troughs 52 adjacent a rearmost portion 54 of inner panel 46. Second troughs 52 direct water flowing therein to the exterior of vehicle 20 adjacent the tail lights.

Rear side portions 56 of inner panel 46 are attached to body 23 with bolts (not shown). Rear side portions 56 include a plurality of weld nut plates 57 that are attached to inner panel 46 with rivets. Weld nut plates 57 are metallic plates having a nut welded thereto. Weld nut plates 57 allow bolts to be used to attach inner panel 46 to body 23 of vehicle 20. A pair of foam seals 58 is disposed between body 23 and rear side portions 56 of inner panel 46. Seals 58 seal inner panel 46 to body 23.

A pair of brackets 60 is riveted to both rear side portions 56 of inner panel 46. Brackets 60 are used to secure biasing members that support lift gate 38 in the open position, as described in more detail below.

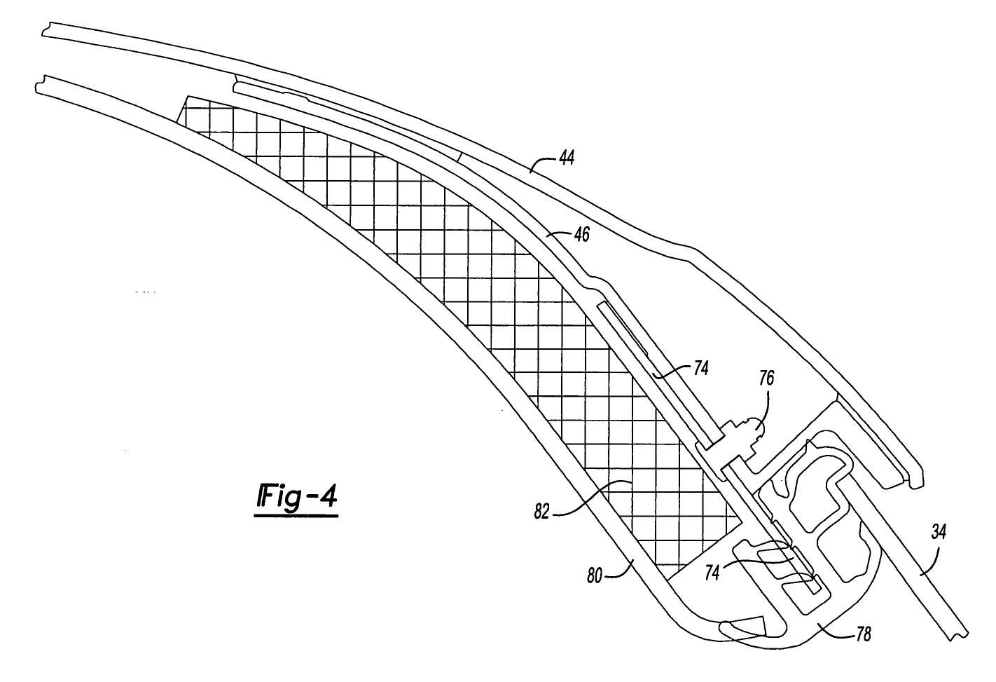

Referring to FIGS. 2A and 3, a front portion 62 of inner panel 46 is attached to a front header 64 of vehicle 20 above windshield 32. Front portion 62 has a plurality of weld nut plates 66 riveted thereto that align with openings in front header 64. Weld nut plates 66 allow front portion 62 to be attached to front header 64 with bolts 68. A weather strip 70 and foam seal 72 are disposed between front portion 62 and front header 64 forward of and behind weld nut plates 66, respectively. Weather strip 70 and foam seal 72 form a weather-tight seal between roof panel 36 and front header 64.

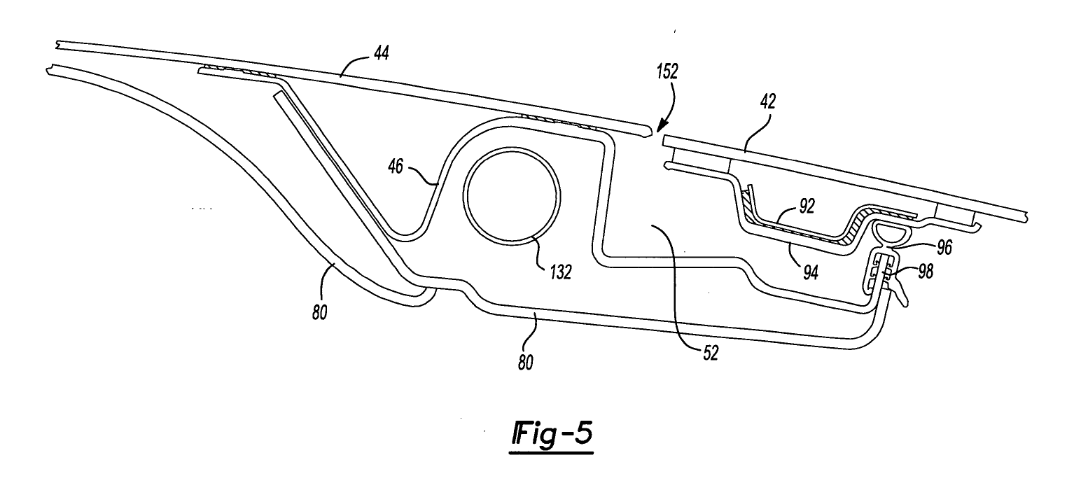

Referring to FIGS. 2A and 4, a pair of weather strip retainer rails 74 is attached with rivets 76 to each side of inner panel 46 adjacent side windows 34. A weather strip 78 attaches to each retainer rail 74 along a side edge. Weather strips 78 engage with side windows 34 to provide a weather-tight seal between roof system 22 and side windows 34.

Retainer rails 74 are preferably made from a flexible or malleable material, such as aluminum. By having retainer rails 74 flexible, retainer rails 74 can be bent to custom tailor the seal formed between weather strips 78 and side windows 34. In this manner, as frameless side windows 34 shift or move over time, retainer rails 74 can be bent or reshaped to accommodate the shifting and ensure a weather-tight seal between roof system 22 and side windows 34.

The inside of inner panel 46 is covered with a head liner 80, as shown in FIGS. 3 and 4. In addition to head liner 80, counter measure 82, such as a dense foam, is disposed at various locations between head liner 80 and inner panel 46. Counter measure 82 is used to soften impacts with roof system 22, as known in the industry.

Referring now to FIG. 2B, details of lift gate 38 are shown. Lift gate 38 includes frame 40, backlite 42 and a decklid 90. Frame 40 and decklid 90 are preferably made from a sheet molded compound. The exterior of decklid 90 is preferably painted to match body 23. Backlite 42 and decklid 90 cover the exterior facing portion of frame 40 such that frame 40 is not directly visible when lift gate 38 is in the closed position, as shown in FIG. 1A. A reinforcement member 92 is riveted to a front portion 94 of frame 40. Reinforcement member 92 is disposed between backlite 42 and frame 40, as shown in FIG. 5. Backlite 42 and decklid 90 are fixedly attached to frame 40 with adhesive and thereby form a single unitary lift gate 38.

A weather strip 96, as shown in FIG. 5, is disposed on a retaining edge 98 of inner panel 46. Weather strip 96 seals against lift gate 38 to provide a weather-tight seal.

Lift gate 38 is coupled to roof panel 36 with a pair of hinge assemblies 100. One part of each hinge assembly 100 is bolted to frame 40 of lift gate 38 while a second part of each hinge assembly 100 is bolted to a bracket on a structural support member, as described below. Hinge assemblies 100 allow lift gate 38 to pivot relative to roof panel 36 between closed and open positions, as shown in FIGS. 1A and 1B.

A pair of studs 102 is attached to the sides of frame 40. Studs 102 allow biasing members 104, shown in FIG. 1B, such as extendible gas cylinders, to be attached to lift gate 38. Opposite ends of biasing members 104 are attached to brackets 60 on inner roof panel 46. Biasing members 104 bias lift gate 38 to the open position and allow lift gate 38 to remain in the open position to facilitate access to storage area 25.

A pair of bumpers 105 is attached to frame 40 and project downwardly toward inner panel 46. Bumpers 105 engage with inner panel 46 when lift gate 38 is in the closed position.

Lift gate 38 also includes a wiring harness 106 and various lights 108 to illuminate storage area 25 and the license plate of vehicle 20. Wiring harness 106 can also include wiring for other accessories, such as a power actuated latch assembly, additional lighting, and sensors, such as a lift gate open sensor, among others.

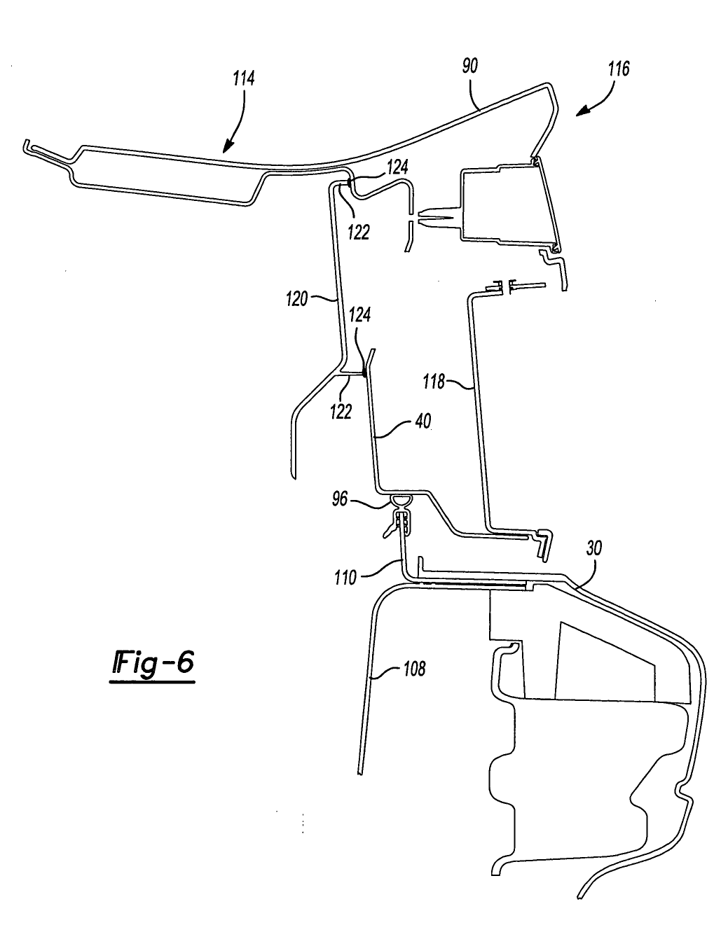

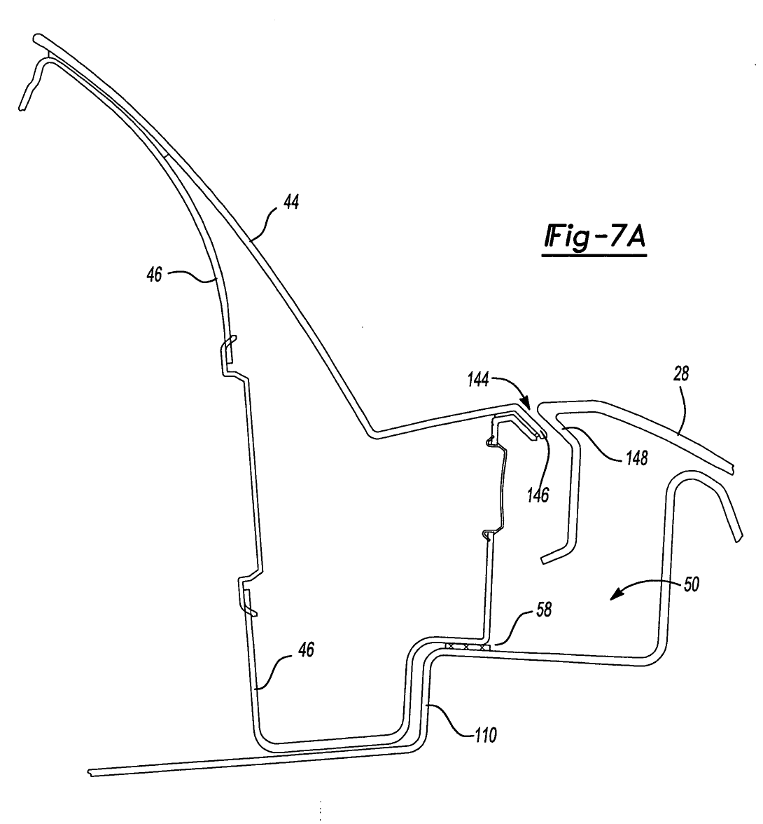

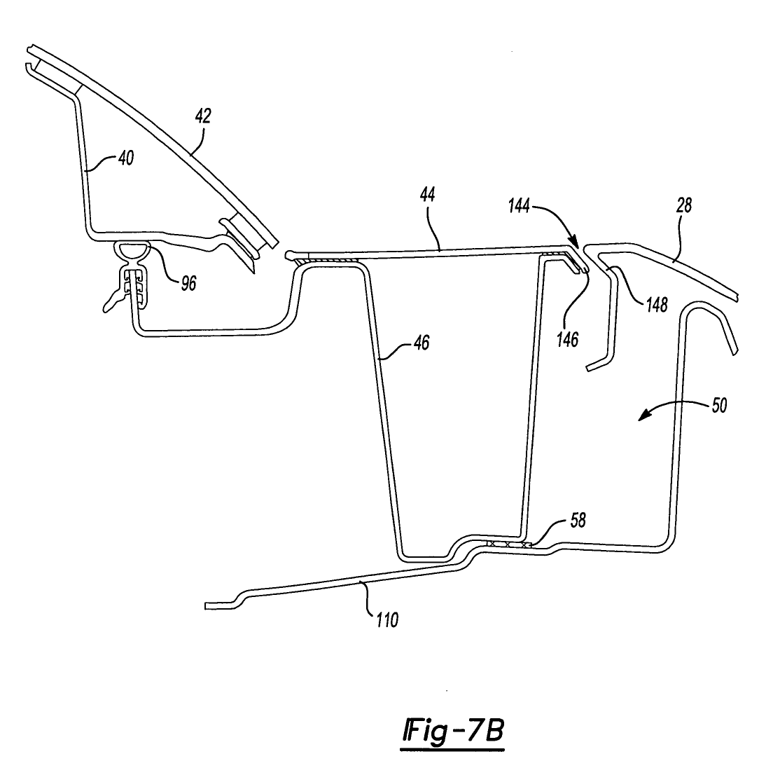

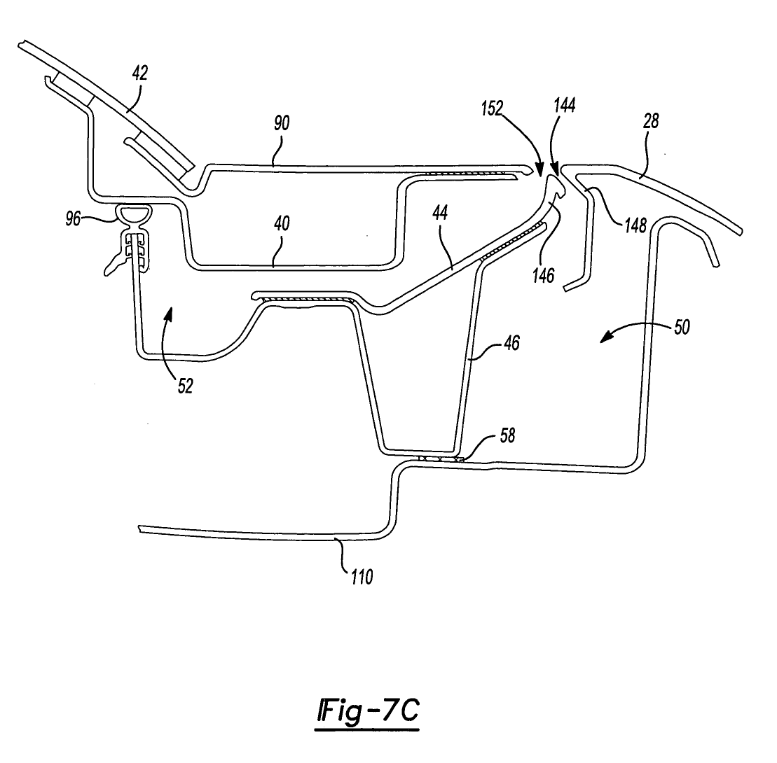

Storage area 25 includes a panel trunk pan 108, shown in FIG. 6, and a panel trunk close out 110, shown in FIGS. 6 and 7A-7C, that provide a desired finish for storage area 25. Close out 110 has an upwardly extending edge on which a portion of weather strip 96 resides, as shown in FIG. 6. Weather strip 96 engages with a rear and downwardly facing portion of frame 40 to provide a weather-tight seal therebetween.

Referring to FIGS. 2B and 6, decklid 90 includes a substantially horizontal portion 114 and a substantially vertical portion 116. Vertical portion 116 forms a part of the rear of vehicle 20. A license plate panel 118 is adhesively bonded to vertical portion 116 of decklid 90. A cover trim member 120 is attached to the inside of frame 40 opposite license plate panel 118. Cover trim member 120 has a plurality of raised ribs 122 that are sealed to the inside of frame 40 with an adhesive sealant 124. Adhesive sealant 124 and cover trim member 120 form an odor proof seal/barrier to prevent vapors and/or odors from the sheet molded components of lift gate 38 from entering into storage area 25 and passenger area 24. Thus, cover trim member 120, in addition to providing a desired appearance for the inside of lift gate 38 also acts as a vapor/odor barrier.

Frame 40 also has a downwardly projecting striker (not shown) that engages with a latch assembly (not shown) on body 23 of vehicle 20. A variety of latching assemblies can be utilized. For example, the deck lid latch disclosed in U.S. Pat. No. 4,971,370, entitled “Self-Raising Deck Lid Latch,” and the trunk lid lock disclosed in U.S. Pat. No. 4,979,384, entitled “Trunk Lid Lock with Remote Release,” the disclosures of which are incorporated herein by reference, can be used as the latch assembly. The striker and latch assembly enable lift gate 38 to be selectively secured to vehicle 20 in the closed position.

Referring now to FIG. 2C, a structural support assembly 130 is shown. Structural support assembly 130 includes a generally U-shaped structural support 132 with ends 134 that are secured within complementary brackets 136 on body 23 of vehicle 20. A plurality of upper brackets 138 are bolted to structural support 132 along with a pair of L-shaped brackets 139. Hinge assemblies 100 bolt to brackets 139. A pair of braces 140 is attached to the corners of structural support 132 and serve to reinforce structural support 132.

Referring now to FIGS. 7A-C, cross-sectional details of first trough 50 are shown. Water enters first trough 50 through an opening 144 between outer panel 44 of roof panel 36 and quarter panel 28 of body 23. A side edge 146 of outer panel 44 slopes outwardly as it extends downwardly. Similarly, a side edge 148 of quarter panel 28 slopes outwardly as it extends downwardly. Opening 144 is between side edges 146, 148. The slopes of side edges 146, 148 causes a vertical overlap of outer panel 44 and quarter panel 28. The overlap between side edges 146, 148 extends the entire length of quarter panel 28. The overlap hides first trough 50 from view regardless of a position of lift gate 38. In other words, a person cannot see vertically into first trough 50. Rather, a person will only see a portion of the sloping side edges 146, 148 when trying to look into first trough 50. Accordingly, first trough 50 is hidden from view. This is advantageous in that a desirable fit and finish is possible with roof system 22. Seal 58 prevents water in first trough 50 from flowing under inner panel 46 and into storage area 25.

Referring now to FIGS. 5, 7B and 7C, cross-sectional details of second trough 52 are shown. Water enters second trough 52 through an opening 152. A portion of opening 152 is formed between the edge of backlite 42 and the edge of outer panel 44, as shown in FIGS. 5 and 7B, while a remaining portion of opening 152 is formed between the edge of decklid 90 and the edge of outer panel 44, as shown in FIG. 7C. Second trough 52 is partially visible when lift gate 38 is in the closed position and entirely visible when lift gate 38 is in the open position.

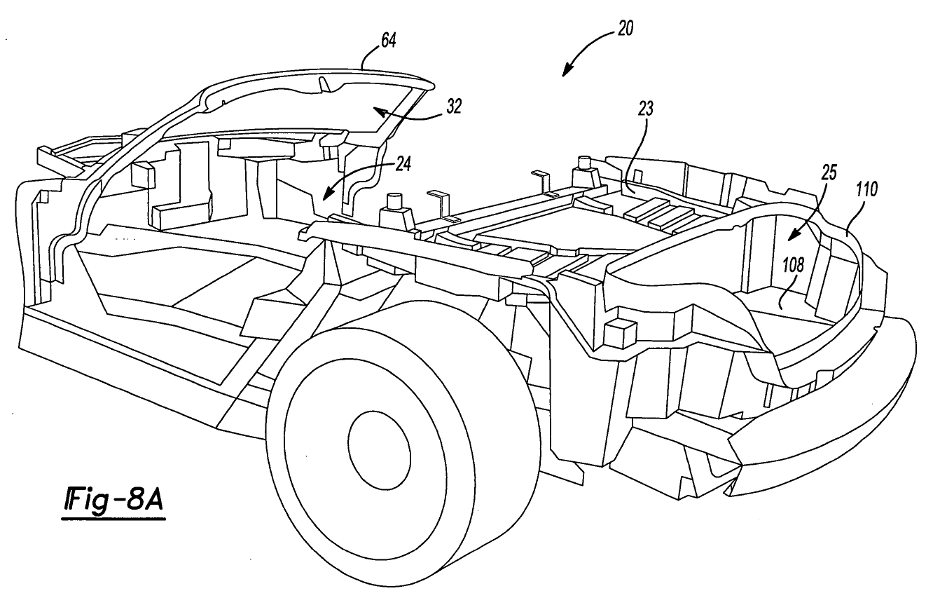

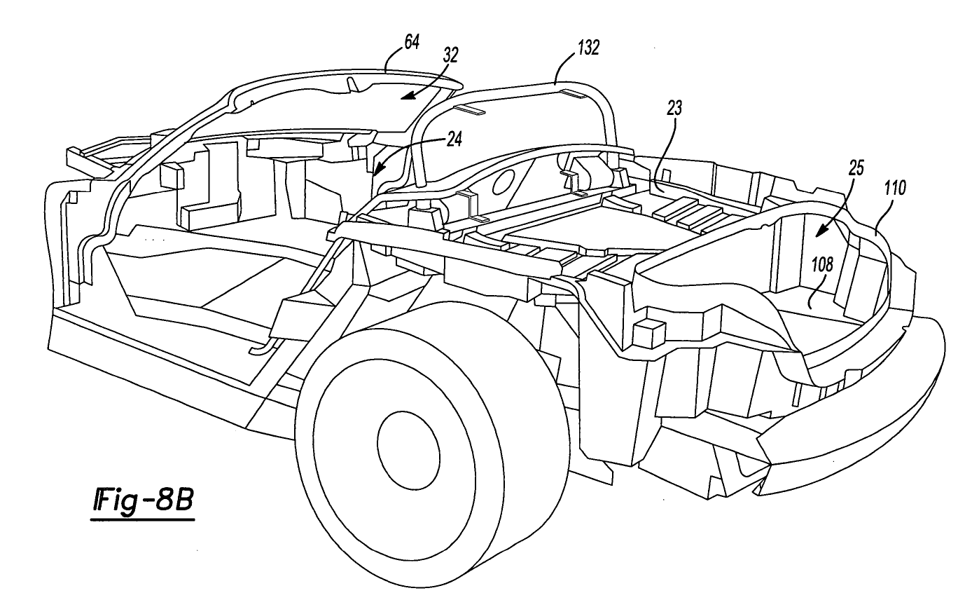

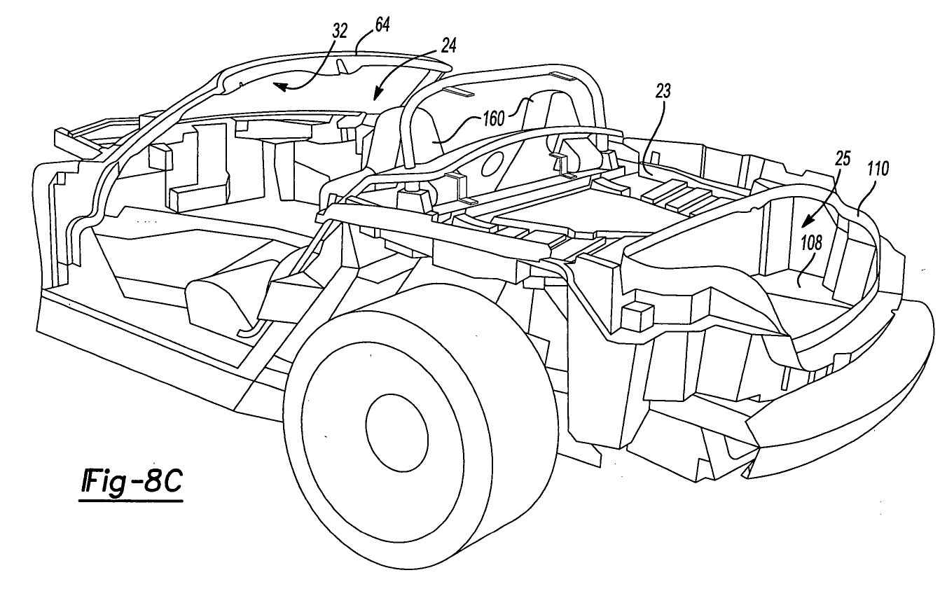

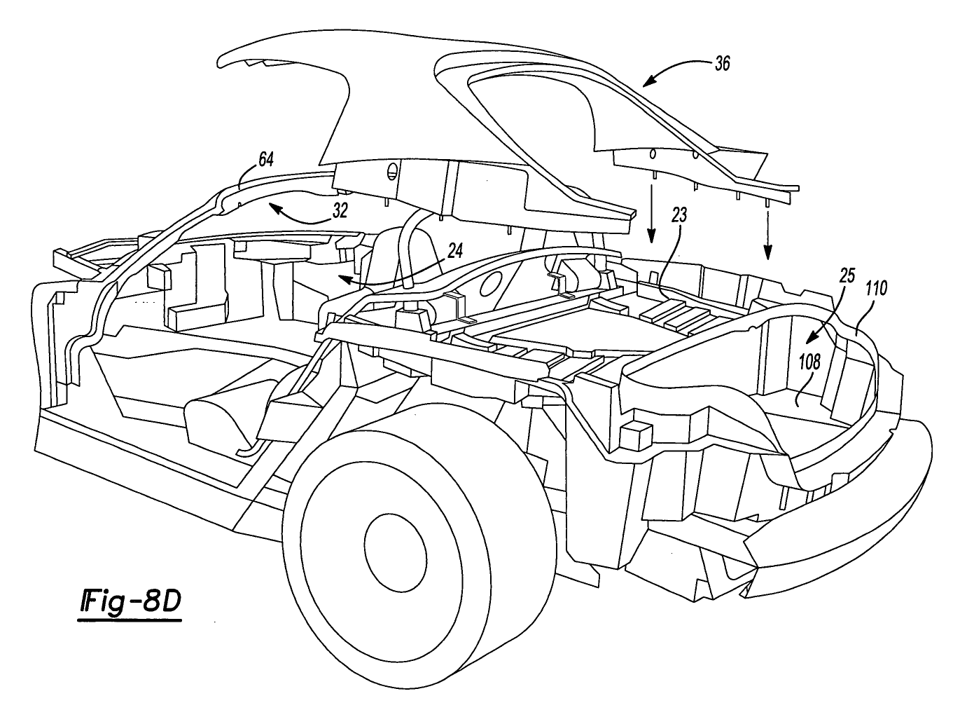

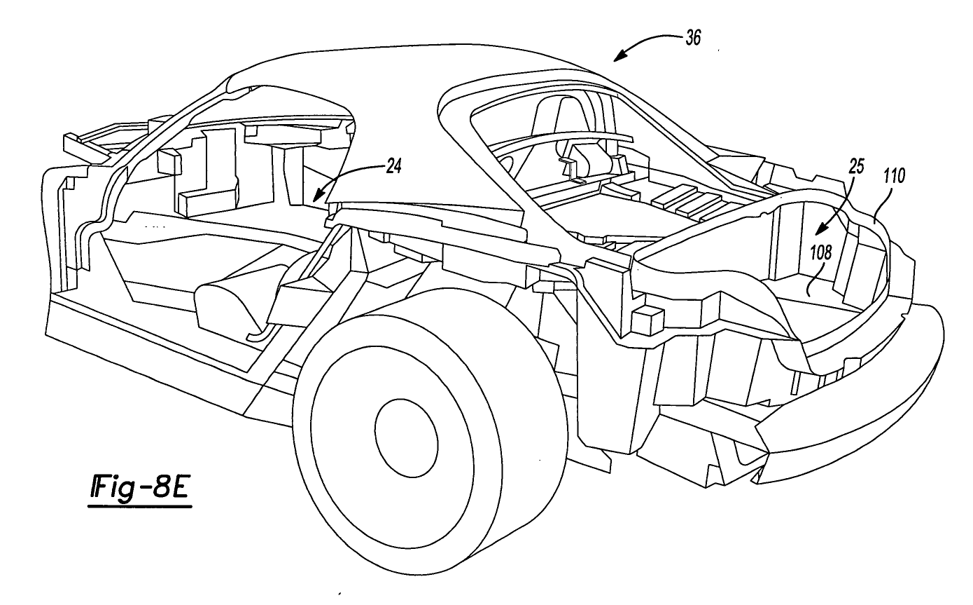

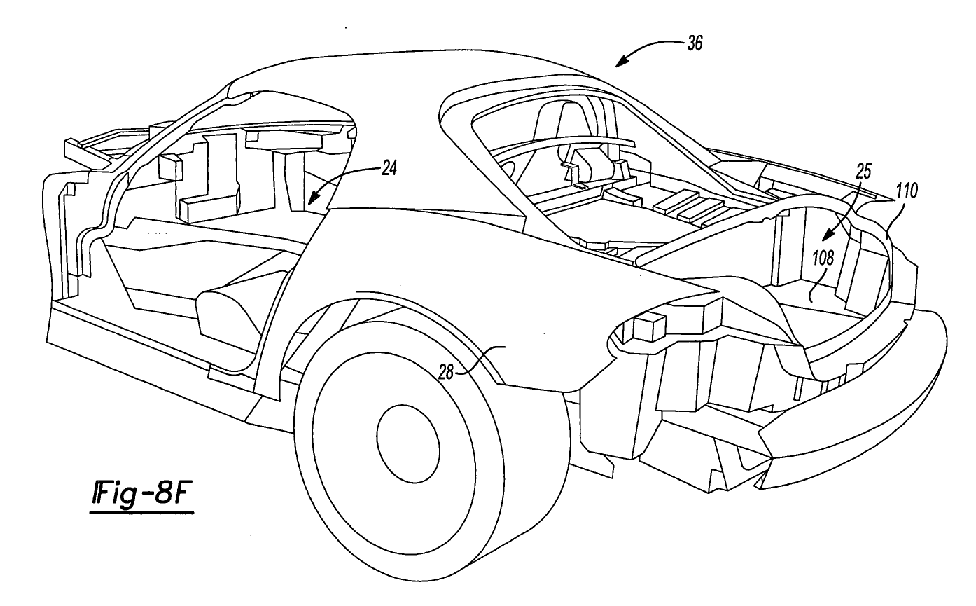

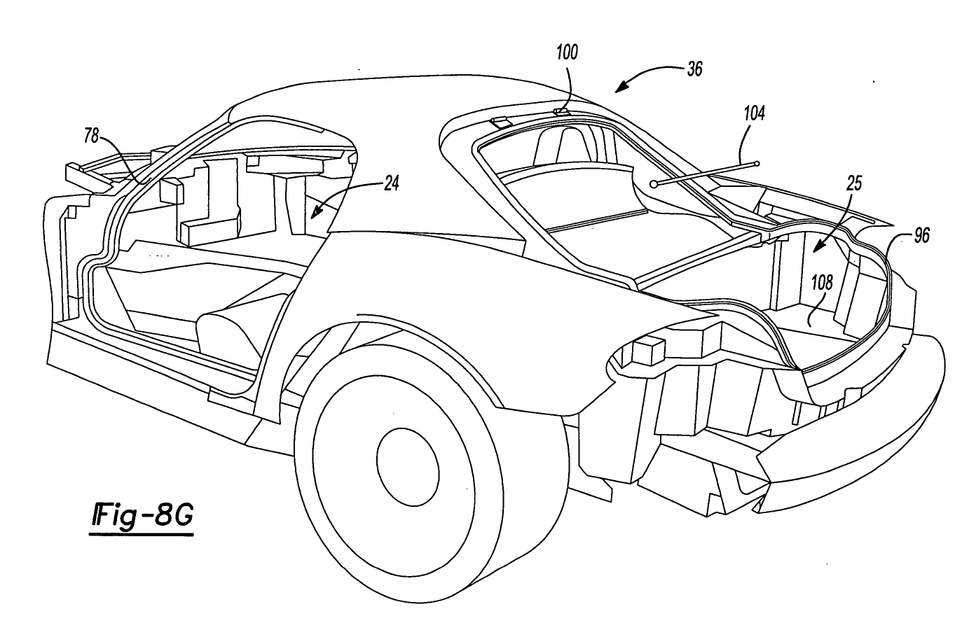

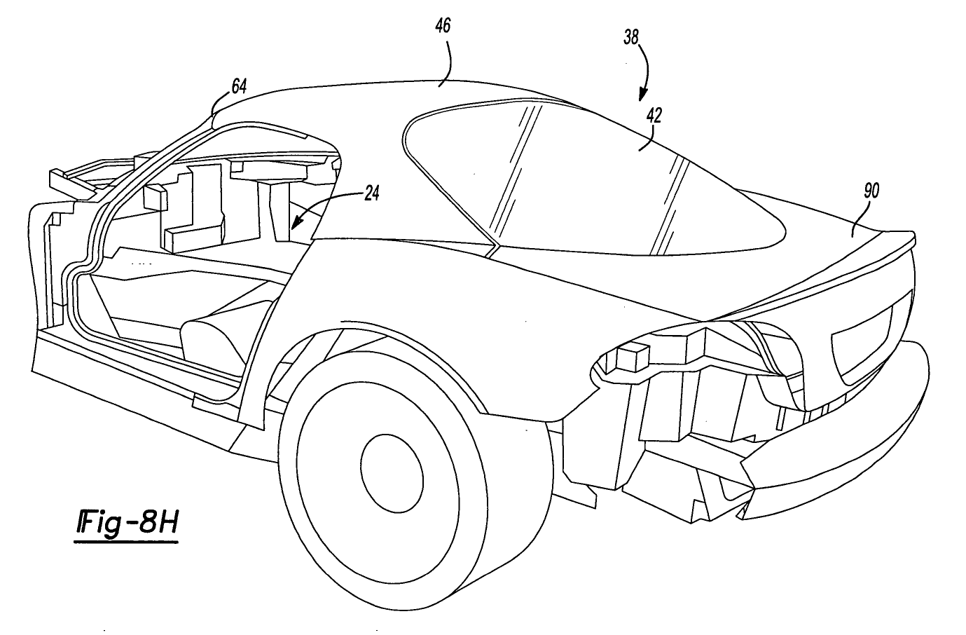

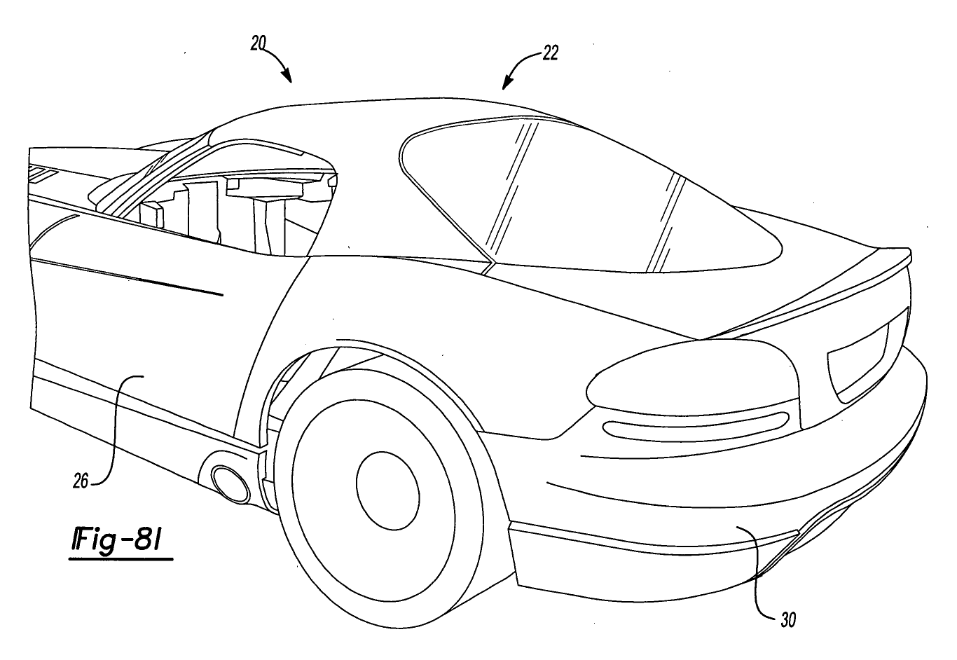

Referring now to FIGS. 8A-8I, simplified details of the assembly of vehicle 20 with roof system 22 are shown. Roof panel 36 and lift gate 38 are assembled prior to attaching to vehicle 20. Roof panel 36 and lift gate 38 can be assembled at a same manufacturing plant as vehicle 20 or at a remote manufacturing plant and brought to the assembly location of vehicle 20. The assembly process starts with vehicle 20, as shown in FIG. 8A, having no doors 26, quarter panels 28 or rear fascia 30 thereon but with panel trunk pan 108 and panel trunk close out 110 already installed. Structural support assembly 130 is installed on vehicle 20, as shown in FIG. 8B, with ends 134 of structural support 132 secured to brackets 136. Next, passenger seats 160 are installed in passenger area 24, as shown in FIG. 8C.

A previously assembled roof panel 36 is then attached to vehicle 20, as shown in FIGS. 8D and 8E. The front portion of roof panel 36 is bolted onto front header 64 with weather strip 70 and seal 72 properly positioned. Side portions of roof panel 36 are bolted onto side portions of vehicle 20 with seals 58 properly positioned. These attachments to roof panel 36 secures roof panel 36 to vehicle 20.

With roof panel 36 secured to vehicle 20, quarter panels 28 are then installed on vehicle 20, as shown in FIG. 8F. Referring now to FIG. 8G, after installing quarter panels 28, weather strip 78 is attached to retainer rail 74 and to the rest of the door opening. Weather strip 96 is also installed on a retaining edge of inner panel 46 and retaining edge 98 of panel trunk close out 110 to form a seal for lift gate 38. Hinge assemblies 100 are attached to brackets 139 on structural support 132. Biasing members 104 are attached to brackets 60 of roof panel 36. Additionally, head liner 80 and counter measure 82 are attached to roof panel 36. Carpet for storage area 25 is also added at this time.

Next, as shown in FIG. 8H, a previously assembled lift gate 38 is fitted into place and attached to hinge assemblies 100. Wiring harness 106 is connected to vehicle 20. Biasing members 104 are attached to studs 102 of lift gate 38. With lift gate 38 installed, rear bumper fascia 30 and side doors 26 are installed, as shown in FIG. 8I. Retainer rails 74 are then adjusted, if needed, to provide a desired seal between side windows 34 and weather strip 78.

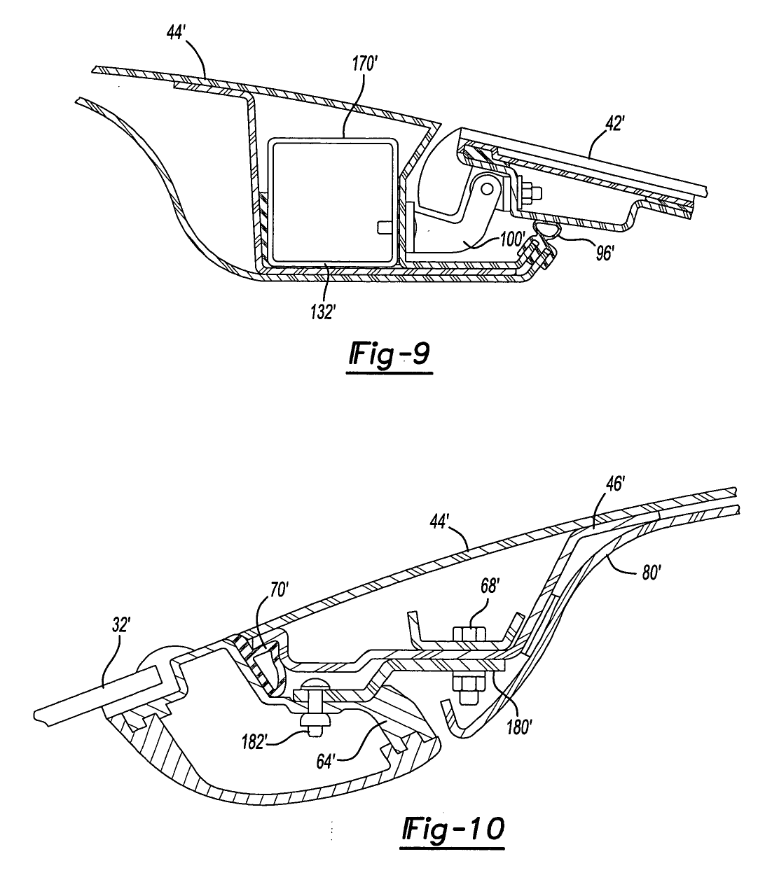

An alternate embodiment of roof system 22′ is shown in FIGS. 9 and 10. Roof system 22′ is very similar to roof system 22 with the main differences being associated with the structural support assembly and the attachment of the roof panel to the front header of the vehicle. Accordingly, only these differences will be shown and discussed.

In this alternate embodiment, a horizontal portion 170′ of structural support 132′ is disposed between inner and outer roof panels 46′, 44′, as shown in FIG. 9. That is, horizontal portion 170′ is sandwiched between panels 46′, 44′. The ends of structural support 132′ are still secured to brackets 136′ (not shown) on the vehicle. Structural support 132′ is assembled along with panels 46′, 44′ to form a single unitary roof panel 36′ that is attached to the vehicle at the appropriate time. Additionally, hinge assemblies 100′ are attached directly to horizontal portion 170′ of structural support 132′ with bolts.

Referring to FIG. 10, the attachment of roof panel 36′ to front header 64′ of the vehicle is shown. In this alternate embodiment, a bracket 180′ is attached to front header 64′ with a knurled rivet nut 182′. Inner panel 46′ is attached to bracket 180′ with bolts 68′. To assemble this embodiment, bracket 180′ can be either attached to front header 64′ and then to inner panel 46′ or attached to inner panel 46′ and then to front header 64′, as desired.

While the preceding description of roof system 22 is shown by way of specific examples, relative dimensions, and structural arrangements, it should be appreciated that variations can be employed with departing from the present invention. Thus, the description of the invention is merely exemplary in nature and variations that do not depart from the gist of the invention are intended to be within the scope of the invention. Such variations are not to be regarded as a departure from the spirit and scope of the invention.

What is claimed is:

1. A hard top roof module for an automotive vehicle, the hard top roof module comprising:
a substantially rigid roof panel selectively attachable to an automotive vehicle; and
a lift gate coupled to said roof panel and extending rearwardly therefrom, said lift gate being selectively moveable relative to said roof panel between first and second positions,
wherein said lift gate includes a backlight portion and a decklid portion.

2. The hard top roof module of claim 1, wherein said decklid portion includes a substantially horizontally oriented surface.

3. The hard top roof module of claim 2, wherein said decklid portion further includes a substantially vertically oriented surface configured to form a portion of a rear end of an automotive vehicle.

4. The hard top roof module of claim 1, further comprising a structural support coupled to said roof panel and attachable to an automotive vehicle.

5. The hard top roof module of claim 4, wherein a majority of a horizontal portion of said structural support is disposed within said roof panel.

6. The hard top roof module of claim 1, wherein said decklid portion is configured to enclose a portion of a storage area in an automotive vehicle.

7. The hard top roof module of claim 1, wherein said lift gate includes an inner panel and an outer panel attached together.

8. The hard top roof module of claim 1, wherein said roof panel includes an inner panel and an outer panel attached together.

9. An automotive vehicle comprising:
(a) a body having a passenger compartment and a storage area rearward of said passenger compartment;
(b) a removable roof system operable to selectively cover said passenger compartment and said storage area, the removable roof system including:
(i) a substantially rigid roof panel selectively attachable to said body and operable to cover a portion of said passenger compartment; and
(ii) a lift gate coupled to said roof panel and operable to cover a portion of said storage area, said lift gate being selectively movable between an open position allowing access to said storage area and a closed position covering said portion of said storage area, a first portion of said lift gate being a backlight and a second portion of said lift gate being a decklid.

10. The automotive vehicle of claim 9, wherein said second portion of said lift gate include a substantially horizontally oriented surface.

11. The automotive vehicle of claim 10, wherein said second portion of said lift gate further includes a substantially vertically oriented surface that forms a portion of a rear end of the automotive vehicle.

12. The automotive vehicle of claim 9, wherein said removable roof system further includes a structural support that extends transversely across said body.

13. The automotive vehicle of claim 12, wherein a majority of a horizontal portion of said structural support is disposed within said roof panel.

14. The automotive vehicle of claim 9, wherein said lift gate and said roof panel each include inner and outer members coupled together.

15. An automotive vehicle roof system comprising:
a removable roof panel, said panel being fixed in place when installed on an automotive vehicle; and
a structural support coupled to said roof panel.

16. The roof system of claim 15, further comprising a lift gate coupled to said roof panel and operable between open and closed positions.

17. The roof system of claim 16, wherein said lift gate includes a backlight portion and a decklid portion.

18. The roof system of claim 15, wherein a majority of a horizontal portion of said structural support is disposed within said roof panel.

19. The roof system of claim 15, further comprising a lift gate pivotally coupled to said structural support and operable between open and closed positions.

20. The roof system of claim 15, wherein said structural support is fixedly coupled to and extends between opposite sides of said vehicle in a cross-vehicle direction.

21. The roof system of claim 15, wherein said structural support is fixedly coupled to said roof panel.

22. An automotive vehicle comprising:
a body having a passenger area and a door that selectively allows access to said passenger area;
a roof panel covering a portion of said passenger area; and
a water trough operable to direct water that flows therein to a desired location, a portion of said trough being substantially hidden from view regardless of positions of moveable members of the automotive vehicle.

23. The automotive vehicle of claim 22, wherein said body includes a fixed quarter panel and said hidden portion of said trough is substantially concealed from view by said fixed quarter panel.

24. The automotive vehicle of claim 23, wherein portions of said quarter panel and said roof panel are adjacent, define an entryway into said water trough, and block a direct view of said water through.

25. The automotive vehicle of claim 24, wherein said adjacent portions of said quarter panel and said roof panel that define said entryway extend outwardly as said portions extend downwardly.

26. The automotive vehicle of claim 22, wherein said hidden portion is below said roof panel.

27. The automotive vehicle of claim 22, wherein said trough extends from a position adjacent a door opening in said body toward a storage area behind said passenger area.

28. The automotive vehicle of claim 22, wherein a moveable component is coupled to said roof panel and operable between open and closed positions and an entirety of said trough is substantially hidden from view regardless of a position of said moveable component.

29. The automotive vehicle of claim 28, wherein said moveable component is a lift gate.

30. The automotive vehicle of claim 28, wherein said water trough is a first water trough and further comprising a second water trough adjacent said first water trough, said second water trough being visible when said moveable component is in a first position and hidden when said moveable component is in a second position.

31. The automotive vehicle of claim 22, wherein a majority of said trough is hidden from view.

32. The automotive vehicle of claim 22, wherein a portion of said trough is substantially hidden from view when looking directly downward at said trough.

33. An automotive vehicle roof system comprising:
a roof panel;
a retaining member extending from said roof panel and toward a frameless window; and
a sealing member attached to said retaining member and operable to seal against said frameless window,
wherein said retaining member is flexible and can be adjusted into an desired position to provide a weather-tight seal between said sealing member and said frameless window.

34. The automotive vehicle roof system of claim 33, wherein said retaining member is adjusted by bending said retaining member.

35. The automotive vehicle roof system of claim 33, wherein said roof panel is a removable roof panel that is fixed in place when installed on an automotive vehicle.

36. An automotive vehicle system comprising:
a frame member;
a panel bonded to said frame member with an interior volume therebetween; and
a trim member covering an access opening to said interior volume,
wherein said frame member, said panel and said trim member enclose a portion of an interior of an automotive vehicle and said trim member being sealed to one of said frame member and said panel and forming a vapor barrier that inhibits vapors within said interior volume from entering said interior of said automotive vehicle.

37. The automotive vehicle system of claim 36, wherein said trim member is sealed to one of said frame members and said panel with an adhesive sealant.

38. The automotive vehicle system of claim 37, wherein said frame member and said panel form a lift gate.

39. The automotive vehicle of claim 37, wherein said panel and said frame are sheet molded compounds.

40. A removable roof system for an automotive vehicle, said removable roof system comprising:
a single substantially rigid roof panel selectively attachable to an automotive vehicle; and
a lift gate coupled to said roof panel and extending rearwardly therefrom, said lift gate being selectively moveable relative to said roof panel between first and second positions,
wherein said roof panel and said lift gate enclose a passenger seating area of an automotive vehicle when installed.

41. The removable roof system of claim 40, wherein said lift gate has a backlight portion and a decklid portion.

42. The removable roof system of claim 41, wherein said decklid portion includes a substantially horizontally oriented surface.

43. The removable roof system of claim 42, wherein said decklid portion further includes a substantially vertically oriented surface configured to form a portion of a rear end of an automotive vehicle.

44. The removable roof system of claim 40, wherein said decklid portion is configured to enclose a portion of a storage area in an automotive vehicle.

45. A method of assembling an automotive vehicle comprising:
(a) providing a body having a passenger area and a storage area rearward of said passenger area;
(b) attaching a removable roof panel to said body with said roof panel covering a portion of said passenger area;
(c) attaching a lift gate to said roof panel with a decklid portion of said lift gate covering a portion of said storage area, said lift gate being moveable between first and second positions relative to said roof panel to selectively allow access to said storage area; and
(d) attaching a backlight to said lift gate.

46. The method of claim 45, wherein said body includes a retractable roof and further comprising removing said retractable roof prior to performing (b).

47. The method of claim 46, wherein (b) includes attaching said roof panel to said body using attachment locations previously used to attach said retractable roof to said body.

48. The method of claim 45, wherein (d) is performed prior to (c) and (c) includes attaching said lift gate with said backlight attached thereto to said roof panel.

49. The method of claim 45, wherein (c) is performed prior to (b) and (b) includes attaching said roof panel with said lift gate attached thereto to said body.

50. A method of attaching a removable roof panel to an automotive vehicle, the method comprising:
(a) attaching a bracket to a front header of the vehicle; and
(b) coupling a front portion of the removable roof panel to the bracket.

51. The method of claim 50, wherein (a) includes attaching said bracket to said front header with a rivet.

52. The method of claim 50, further comprising attaching a rear portion of the removable roof panel to a body of the vehicle.

53. The method of claim 50, wherein the removable roof panel is a sheet molded compound.
